(19) United States
(12) Patent Application Publication
(10) Pub. No.: US 2011/0066792 A1
(43) Pub. Date: Mar. 17, 2011

(54) Segmentation Of Flash Memory For Partial Volatile Storage

(75) Inventors: Ian Shaeffer, Los Gatos, CA (US); Brent Haukness, Monte Sereno, CA (US)

(73) Assignee: RAMBUS INC., Los Altos, CA (US)

(21) Appl. No.: 12/812,745

(22) PCT Filed: Feb. 4, 2009
(86) PCT No.: PCT/US09/33104

§ 371 Date: Jul. 13, 2010

Related U.S. Application Data
(60) Provisional application No. 61/027,468, filed on Feb. 10, 2008.

(51) Int. Cl. G06F 12/00; G06F 12/02

(52) U.S. Cl. 711/103; 711/E12.001; 711/E12.008

(57) ABSTRACT

This disclosure provides a method and system that segment flash memory to have differently managed regions. More particularly, flash memory is segmented into a “non-volatile” region, where program counts are restricted to preserve baseline retention assumptions, and a “volatile” region, where program counts are unrestricted. Contrary to conventional wisdom, wear leveling is not performed on all flash memory, as the volatile region is regarded as degraded, and as the non-volatile region has program counts restricted to promote long-term retention. More than two regions may also be created; each of these may be associated with intermediate program counts and volatility expectations, and wear leveling may be applied to each of these on an independent basis if desired. Refresh procedures may optionally be applied to the region of flash memory which is treated as volatile memory.

This document claims the benefit of U.S. Provisional Patent Application No. 61/027,468 for Segmentation Of Flash Memory For Partial Volatile Storage, filed by inventors Brent Steven Haukness and Ian Shaeffer on Feb. 10, 2008, which is hereby incorporated by reference.

This disclosure relates to memory circuits, and more particularly, to memory that suffers from life-cycle wear, such as flash memory.

### BACKGROUND

Modern forms of main memory are conventionally based on dynamic random access (“DRAM”) technology. DRAM offers many advantages over other types of memory, including excellent long-term retention characteristics. However, the cost, form factor, power requirements and thermal characteristics of DRAM are less than optimal for certain classes of devices, including certain portable or low-cost devices.

There are classes of memory that are low-cost and that have low power consumption, and thus present an attractive alternative to DRAM; flash memory is one such class of memory. However, some of these classes of low-cost memory, including flash memory, suffer from use-based degradation. That is to say, the more often memory is accessed, the more its retention capability is degraded. This “program count” wear, e.g., the count of times a particular memory cell has been programmed, is a significant limitation that has conventionally inhibited use of these classes of memory. As individual memory cells are written to again and again (i.e., “programmed”), the retention capabilities of those cells gradually decrease; while processes such as wear leveling may be applied to minimize the impact of this wear upon a memory device as a whole, the wear still occurs, albeit in a more evenly distributed fashion, and retention time changes for these devices over time. This variability creates design challenges, since degradable memory generally starts out its life cycle as memory that is fundamentally non-volatile in nature, but over time and through extensive use, this nature changes.

A flash memory cell with no program count history may be capable under current technology of non-volatile retention measured in years, whereas a flash memory cell that has a high program count history (e.g., that has been subject to tens of thousands of programming operations of more) may have a retention capability measured in minutes, seconds or even fractions of seconds. This variability creates design challenges, and has led to reluctance to use degradable memory, such as flash memory, in some applications.

The effects of this degradation are especially acute for types of memory that are erased or programmed in blocks (or other memory subdivisions). Flash memory, for example, is usually either NOR-based or NAND-based, with NOR based memory requiring both erasure in units of blocks (typically several kilobytes) and programming in multi-byte units, and NAND-based memory requiring erasure in units of blocks and programming in units of pages (with typically a large number of pages per block). That is to say, with these types of memory, it is generally not possible to selectively erase and program individual memory locations, but such must be done in bulk; this limitation is an artifact of the small form factor and low power design of these types of memory. As this discussion implies, turnover for even limited amounts of flash memory leads to bulk erasure and reprogramming of entire blocks or pages, i.e., changing one byte requires reprogramming the entire block or other minimum erasing or programming unit, and this design further contributes to the program count wear issue for flash memory.

What is needed is a method of adapting degradable memory for use in applications traditionally reserved for other forms of memory.

### BRIEF DESCRIPTION OF THE DRAWINGS

FIG. 1 is block diagram of a memory system where flash memory is segmented for different management; a demarcation between storage regions is depicted by dividing line 116 in FIG. 1.

FIG. 2 is a block diagram of a method of segmenting flash memory for different management; as indicated by FIG. 2, a first region may be used for general purposes and a second region may be reserved for data that is to be accessed following a reduced power mode.

FIG. 3 is a block diagram of a memory system including plural flash devices; in the embodiment of FIG. 3, regions are segmented across flash memory as a whole.

FIG. 4 is a block diagram of a memory system including plural flash devices; each of several devices is segmented so that demarcation occurs within individual devices. That is to say, unlike the embodiment of FIG. 3 where regions are defined in continuous address space, in the embodiment depicted in FIG. 4, regions are defined in parallel across several devices. If desired, demarcation information can be stored for each device, as depicted by reference numeral 419.

FIG. 5 is a block diagram of a method of managing data using flash memory segmentation; in particular, data to be written into flash memory is (depending on type) associated with a specific level of volatility and written into a region corresponding to that volatility.

FIG. 6 is a block diagram of a method of planning or designing a flash memory system where regions within flash memory are to be segmented and managed differently; as indicated by FIG. 6, the implementation may be made to depend on factors such as system requirements and whether other memory types (such as DRAM) are available to the system. The method of FIG. 6 may be implemented if desired by software, including software that configures a system for initial use or that periodically optimizes system performance.

FIG. 7 is a block diagram of a method of reallocating flash memory between regions based on certain triggers, depicted at the right side of FIG. 7. The triggers may include wear to individual storage regions that impinge upon predetermined minimum certain limits, as well as changing system parameters, addition or removal of hardware or memory, memory malfunction, and other parameters.

FIG. 8 is an architectural level diagram illustrating an embodiment where an operating system and memory subsystem controller make use of four segmented regions of flash memory, each the subject of different handling and treatment.

FIG. 9 is a block diagram of one exemplary method of performing wear leveling upon individual regions of flash memory.

FIG. 10 is a block diagram of one exemplary method of replacing individual flash memory devices, and for managing impact upon region definition.

FIG. 11 depicts a method of handling a power mode transition, such as a sleep, standby, or power down event.

FIG. 12 depicts a method of handling a power mode transition, in particular, a wake-up event.

### DETAILED DESCRIPTION

The enumerated claims may be better understood by referring to the following detailed description, which should be read in conjunction with the accompanying drawings. This description of one or more particular embodiments, set out below to enable one to build and use various implementations, is not intended to limit scope of the disclosed technology, but to exemplify its application to certain methods and devices. The description set out below exemplifies specific methods and systems that adapt flash memory to better manage operations on a predicable basis. The principles discussed herein, however, may also be applied to other methods and devices as well.

### I. Introduction

In part to address the issues identified above, the present disclosure provides a method of managing flash memory in a manner that it can be used for a broader range of applications, potentially even including main memory applications. Ideally, this method can be practiced with conventional “off the shelf” flash devices, which are generally quite cost effective relative to other forms of memory or special purpose devices.

In accordance with this method, flash memory may be divided into two or more storage regions, each of which will be managed differently. To enhance the ability to use flash memory in a wide range of possible applications as a primary memory solution, at least one storage region is used for volatile memory operations and at least one other storage region is used for operations where memory contents are to be retained following transition to a reduced power mode (e.g., for non-volatile operations). [A “low-power” or “reduced power” operating mode, as used herein, will refer to any mode in which an overall system is scaled back to use less power, including without limitation a system shut-down or a situation where a system is put in a state where any regularly applied refresh operations are slowed or removed. The term “non-volatile” as used herein refers to a relative term associated with memory retention in the absence of normally applied power or refresh procedures.] That is to say, to better manage the variability of retention times, flash memory is proactively managed to segment flash memory into regions, and then to manage the use of those regions so as to preserve certain assumptions about the retention times, characteristics and treatment of each segment. Part of flash memory can be modeled as non-volatile memory with restrictions placed on its usage so that program counts stay low (thereby preserving expectations regarding non-volatility, i.e., memory operations are proactively managed so that a region's non-volatility does not change appreciably through use), while another part of flash memory can be modeled and managed as volatile memory, to mange the memory in a manner compatible with a fixed state, such as eventual long-term, high program count wear; that is, the second region may be consistently treated as volatile memory even if its memory cells have in fact not yet degraded significantly and will only degrade slowly over time. If desired, this partitioning can be applied to a single device (such as a memory chip or flash card) or it can be applied to an entire bank of devices (such as a memory module based on multiple flash devices).

The method described above may be accompanied by still further refinements depending on desired implementation. For example, for regions managed as essentially volatile memory, it may be possible to assume retention times that are so short that it is not necessary to perform wear leveling; flash memory cells manufactured using current state-of-the-art technology may not in fact degrade to this degree until subjected to program counts in the millions, and consequently, it may be presumed for some applications that program counts will never reach this level, even without wear leveling. To tailor memory design to the particular implementation, the designer need only understand the effects of wear on the particular memory devices under consideration (typically published by the device manufacturer, or otherwise readily available to a designer), and the demands that will be made upon the memory devices by the applications under consideration. Depending upon the retention time that is to be imputed to a region of memory, a designer may wish to use refresh techniques in order to provide continued “volatile” memory retention while the system is in a normal mode of operation. Conversely, for regions essentially managed as non-volatile memory, where imputed retention time is relied upon to be measured in years, it may be desired to carefully restrict usage so as to avoid degradation to a point inconsistent with the imputed retention characteristics of that region. If some moderate (but not excessive) amount of programming is permitted, it may be desired to perform wear leveling on an occasional basis (e.g., as soon as any block within a region experiences “n” program cycles) just for that region in order to distribute wear, so as to preserve the region's retention assumptions for as long a period as possible. [Wear leveling techniques are also well understood in the art, with many choices of algorithm available to a designer, depending on design objectives.]

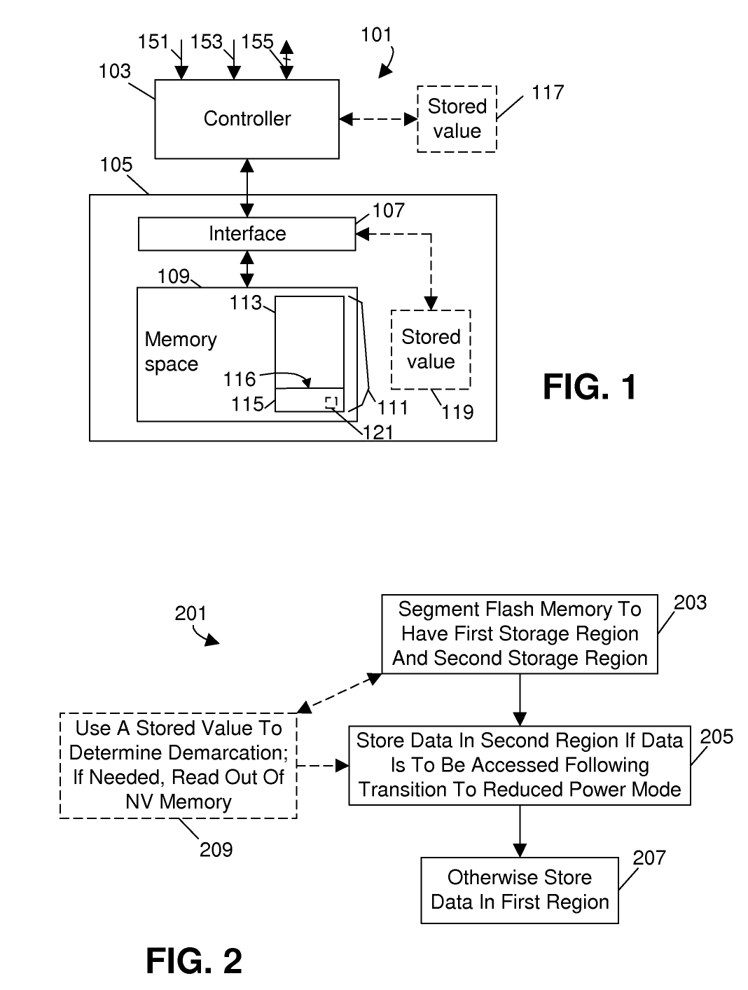

FIGS. 1 and 2 are used to introduce a system and a method that implement flash memory segmentation.

As seen in FIG. 1, a memory system 101 includes a controller 103 and flash memory 105. The memory 105 may include a single memory device, or alternatively, plural devices, configured with a controller as part of a memory module (the controller, 103 would in this event be depicted within block 105). An interface 107 is used to couple the controller with memory storage space 109 and serves to provide interpretation of commands from the controller, including row select, column select and other traditional memory cell control functions. In FIG. 1, a memory map pictograph 111 is used to collectively represent a number of memory locations, which have been divided into a first storage region 113 and a second storage region 115. In accordance with the principles introduced above, the first storage region 113 will be treated as volatile memory and the second storage region 115 will be managed so as to preserve a specific assumption about duration of non-volatility, e.g., long-term non-volatility. As mentioned above and as will be further discussed below, it is also optionally possible to define additional regions, with intermediate assumptions (e.g., occasional reprogramming permitted, with intermediate expected retention time).

If desired, demarcation between the regions may be architecturally-defined (e.g., on a fixed basis, such as the lowest “n” thousand pages of memory), or demarcation may be made tunable, depending on environment. This demarcation is symbolically depicted in the pictograph 111 of FIG. 1 by a dividing line 116. [As used herein, the term “demarcation” should be understood to mean any definition of or distinction, boundary or other division between two or more regions of memory that is practiced, even if no physically observable indication of distinction, boundary, partition or division is visible in the system or any one of its elements (e.g., even if it is practiced exclusively by software, but not hardware, by hardware but not software, or in some other manner). For example, the term “demarcation” may include, without limitation, programmatically established definitions (such as might be established using a one-time programmable circuit or run-time programmable register to store one or more values that indicate address boundaries between two or more memory regions), architecturally-established definitions, definitions established by hardware or through a specific instruction set, or by some other manner.] Generally speaking, whether demarcation is architecturally-defined or is made tunable (e.g., programmable) depends upon the particular design. If architectural demarcation is used, the location of the demarcation may be effected by different handling of address segments, e.g., effectively handled by controller or system firmware; if a tunable demarcation is used, the system can retrieve and store demarcation parameters in a location close at-hand, for ready system use. FIG. 1 depicts three different locations where a partition value may be stored to identify demarcation including in (i) memory local to a flash memory controller (depicted by reference numeral 117), (ii) memory that is associated with flash memory space in general (such as a memory module serial presence detect register, also encompassed by reference numeral 117 in FIG. 1), and (iii) a specific location closely associated with flash memory itself, 119. For example, if it is desired to store values in a flash memory device itself, the information may be stored within an extended page, a one time programmable (“OTP”) register, or as indicated by reference numeral 121 in FIG. 1, a reserved location within the second memory storage region 115 (i.e., the region reserved for non-volatile storage). FIG. 1 also shows a number of control inputs 151 and 153, and a memory subsystem input-output (10″) bus, which will be further referenced below.

FIG. 2 depicts a method 201 that implements some of the principles discussed above. In particular, memory may be partitioned into at least two segments, as identified by function block 203. Generally speaking, a first storage region is identified which will be used for volatile storage (with or without refresh) and a second storage region is identified which will be restricted in use and managed so as to promote assumptions of long-term, non-volatile storage, as was mentioned above. In operation, when data is to be written into flash memory, if the data is of such a nature that it is to be accessible following a reduced power mode, data is stored in the second storage region (that is, a “non-volatile” region) as indicated by function block 205. As used herein, “reduced power mode” should be understood to encompass a power down, or device shut off, sleep or standby modes, as well as other situations where device operation is changed to conserve power. In practice, the method of FIG. 2 may be employed to store critical system information in this manner, such as for example, memory management information, bad memory block information, and system parameters of a similar nature. If desired, a third or additional storage region may be created, with this information being stored under assumptions of intermediate-duration non-volatility. If desired for a particular implementation, information could be stored in a third region associated with approximately three months' non-volatility, with the system configured to run a memory reassessment subroutine if the system was not normally used within this time frame. For example, bad block information (e.g., blocks where there exist one or more memory cells that are inoperative, or where memory retention is inadequate to a point relative to expectations to render the memory unreliable) could be stored in such a region. Finally, if the information is such that the information can be lost upon a power down without significant impact (other than restarting an application), the information can be stored in a first, “volatile” storage region, as indicated by function block 207. This may be the case, for example, for certain types of operands and application data that are normally stored in “slow” memory such as on hard disk, on CDROM, and so forth, where copies of this data are loaded into main memory for use in a particular application and, thus, where it is not critical if a copy data is lost from volatile memory.

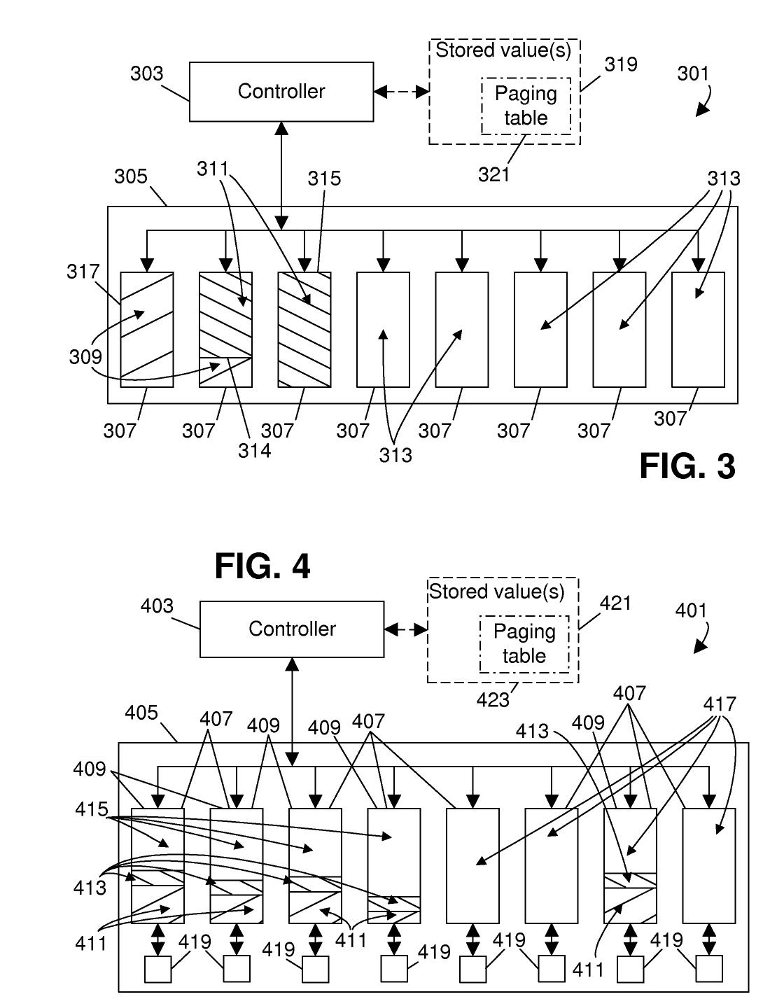

With a method and system for segmenting degradable memory thus introduced, additional detail will now be discussed, with reference to FIGS. 3-12.

### II. Design Considerations

A. Parallel Versus Series Configuration of Regions.

FIG. 3 shows one embodiment of a memory system 301 that includes a flash memory controller 303 and a group 305 of flash memory devices 307. In the embodiment represented by FIG. 3, three regions are defined as spanning the range of flash memory, including a first storage region 309 (diagonal wide shading), a second storage region 311 (diagonal narrow shading) and a third storage region 313 (no shading). It should be observed that in this embodiment, a demarcation 314 between the first and second regions, and a demarcation 315 between the second and third regions each occur in at most in one of the memory devices, or potentially between memory devices (e.g., individual memory devices could be dedicated to a single region only, such as a first device 317). In the embodiment of FIG. 3, the demarcations could be architecturally-defined, with the system “knowing” where the regions are located based on a fixed-by-design architecture or, as mentioned above, the demarcation information could be represented by stored values, as indicated by optional functionality represented by a dashed-line block 319. These stored values may also take the form of information in a paging table, as represented by a second dashed-line block 321. That is to say, it may be preferred for some implementations (since flash memory is conventionally written in units of pages) to discretely index each flash page to a region, and vice-versa (i.e., each region to a group of specific pages), for wear leveling and other purposes; also, as will be discussed further below, if it is desired to use an expandable memory system or a memory that permits selective replacement of units of flash memory (for example, for reasons associated with degradation), a paging table such as indicated by block 321 provides a convenient way to manage memory and reallocate memory between regions if desired.

FIG. 4 presents an embodiment similar to FIG. 3, but in which regions may be divided across multiple memory devices, with at least select devices having memory space dedicated to each region, i.e., the regions may be discontinuous across the memory space as a whole. In particular, FIG. 4 shows a system 401 having a controller 403 and a group 405 of memory devices 407. Five memory devices, identified using reference numeral 409 in FIG. 4, are seen as having been individually segmented into three regions 411 (diagonal wide shading), 413 (diagonal narrow shading) and 415 (no shading), with a portion of memory space for each device dedicated to each region. Three memory devices are depicted in FIG. 4 as allocated only to the third region (or alternatively, held in reserve and not allocated to any region, which may be desired in some implementations). FIG. 4 also shows the use of stored values, either in isolation or in the form of a paging table (421 and 423, respectively); if desired, since each memory device may be individually segmented in the embodiment of FIG. 4, it may be desired to store demarcation information identifying the break between regions in non-volatile storage within each specific device in local storage, depicted by reference numeral 419 in FIG. 4. As indicated earlier, this device-based storage may occur in a non-volatile segment of memory, in a one time programmable (“OTP”) register, in an extended memory page, or in some similar manner.

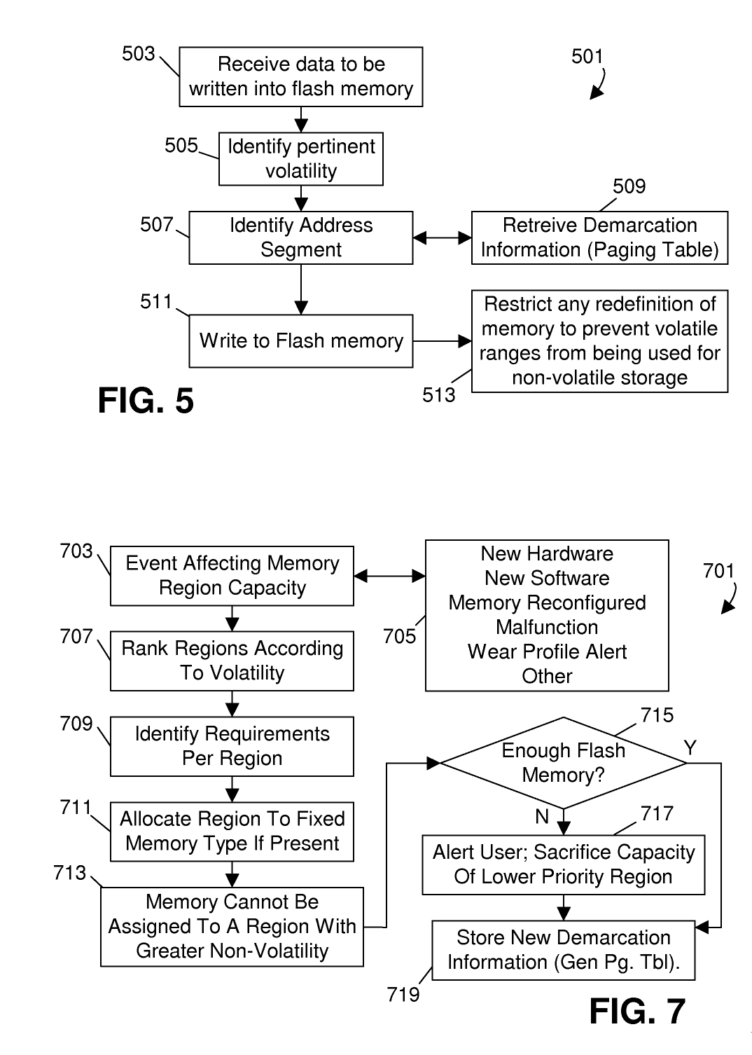

FIG. 5 presents a method 501 of writing data to a memory system. A system receives data to be written into memory and associates that data with a level of volatility, as represented by function blocks 503 and 505. Volatility can be indicated in a number of ways, including an instruction set architecture that indicates a volatility level or a specific storage region indicated directly as part of the write instruction (this embodiment will be discussed further below). Alternatively, desired volatility can be presumed based on data source, e.g., one region may be reserved exclusively for specific operations of a memory controller and another for an operating system. Other methods of indicating volatility are also possible. In a three-region memory system that employs principles discussed herein, a system flash controller could reserve one region for very low program count information (such as storage of “bad” flash block or page information or other memory system parameters), a second region for operating system parameters (not specific to the memory controller) that need to be written to non-volatile memory with each “standby” operation (e.g., where expectation is that the system will be brought out of standby within minutes or hours), and a third region associated with unrestricted “volatile” storage, where refresh procedures might be applied to flash memory on a periodic basis. In such a system, firmware supporting the flash controller may be configured to identify data source and impute volatility to data to be written to memory based on that source. Irrespective of method of identifying an appropriate storage region, once the region is identified, an address segment is selected (i.e., within a specific storage region) based on the identified parameters, as represented by function block 507; other inputs may also be used to determine the appropriate segment, such as demarcation information 509, paging information which indicates an appropriate page into which new data may be written as part of a programming operation, and so forth; a resultant write operation 511 programs the data to selected memory. Finally, as indicated by function block 513, wear profile information specific to the region into which data is written is modified to indicate completion of another programming operation for the affected page. As implied by this discussion, each region may have unique wear profiles kept and tracked, and different wear leveling algorithms and procedures, if any, may be applied to each region. For example, if a system experiences heavy use, memory may eventually become degraded to a point where fixed assumptions of retention times applied pursuant to this disclosure no longer are valid and wear profiling may be used to reassign memory from one storage region to another. Wear profiling and related procedures which may be implemented as indicated by function block 513 will be discussed further below, in conjunction with the discussion of FIG. 7.

B. Planning Region Capacity; Fine Tuning of Regions.

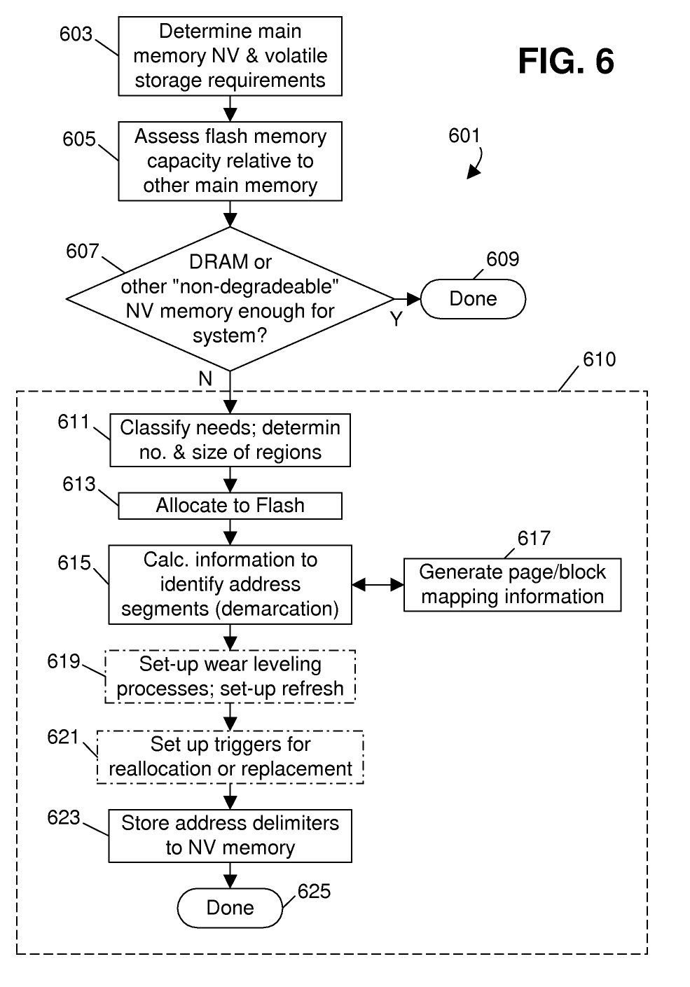

As indicated by the discussion above, some implementations may utilize region demarcation which is architecturally-defined, based on system design goals; other implementations may use tunable region designs, with demarcation being locally-stored and (if appropriate) programmably-defined. FIG. 6 illustrates a method 601 by which region structure may be decided upon and region size defined for use in a particular application.

The method 601 may include determining main memory volatile and non-volatile storage requirements, per numeral 603. In approaching this task from a system level approach, a designer may wish to consider overall system storage requirements, memory subsystem storage requirements (e.g., for subsystem control purposes), and application specific requirements such as need for quick power up; clearly, in applications where quick power-up is required, it may be desired to provide for large amounts of non-volatile “fast” storage in main memory, such that main memory can keep operating parameters essentially pre-loaded. As indicated by function block 605, consideration of the design task may also involve assessing the existence of other memory in a mixed memory system; other forms of memory can include availability of hard disk storage, DRAM storage, large cache size in either a CPU or controller, or other forms of memory. In a system in which a CPU has large amounts of non-volatile cache, it may not be necessary to provide for large amounts of non-volatile flash memory, and the converse may be true, i.e., in some systems where there is relatively little non-volatile cache or other memory, it may be desired to reserve a larger region of flash memory as non-volatile. Similarly, if a system features large amounts of DRAM, it might be possible to use DRAM for primary volatile storage with only a small amount of flash based memory devoted to this purpose. Some applications may feature only flash memory, for example, in certain cell phone, portable or other special purpose applications. Alternatively, some implementations (especially using the teachings of this disclosure) may provide for a general purpose computing platform with main memory based primarily, or even solely, upon flash memory.

Accordingly, per numeral 607, the method may include determining whether other memory present among desired system hardware is more appropriate for a particular type of storage and, if it is, the method can be resolved, as indicated by block 609. If not enough alternate memory sources are available, flash memory may then be segmented according to the design principles discussed above, and as represented by numeral 610 in FIG. 6.

For memory requirements not fulfilled by other types of memory, the requirements may be classified and a number of regions decided upon, with sizing to meet contemplated platform needs and contemplated system hardware and software growth, as appropriate. If desired, a third or additional region may be allocated simply to reserve unallocated flash space to provide a replacement pool for nonvolatile flash memory worn out over time through heavy use. Once the number of regions has been decided upon and appropriate sizing determined, these regions are allocated to specific flash locations. Should needs be greater than available flash memory, a designer may change advance system design to readjust allocations, for example, by providing for a smaller amount of unallocated flash memory, or by reducing the size of one region to provide added capacity for another. In some implementations local non-volatile storage may be sacrificed or traded off (for example, by taking certain system parameters and writing them to hard disk, if available, upon a power mode transition) for greater volatile storage capacity in flash; in other implementations, it may be desired to sacrifice volatile storage to provide for greater capacity for local non-volatile storage of system parameters (for example, for an implementation where quick system wake-up is desired). These functions are collectively represented by numerals 611 and 613 in FIG. 6.

Once region structure is decided upon, specific address segments and demarcation between those segments (corresponding to region definition) may be decided upon, and pages and blocks may be assigned as appropriate, designated by reference numerals 615 and 617. A designer may provide for wear leveling or refresh processes for each region, as implied by optional, dashed-line block 619. FIG. 6 also shows a second dashed-line, optional block associated with reallocation or replacement, identified by reference numeral 621. In this regard, a designer may choose an implementation where regions and associated retention times are associated with typical use, but where heavy use may cause memory cells within a region to be degrade to a point where expected retention time is less than the retention time imputed to a region. Such an implementation might be chosen, for example, to meet design requirements of a greater amount of non-volatile storage. To deal with wear during system lifetime, a mechanism may be provided to enable memory from one region to be later reassigned to another region, or where the owner of a system may be prompted to replace memory, for example with a new memory module; reallocation and replacement will be discussed below, in connection with FIG. 7. In these situations, it may be advantageous to use an “adjustable” region definition and associated demarcation, as was alluded to earlier.

Once regions have been planned, particularly if a tunable implementation is decided upon, it may then be appropriate to write demarcation information to a stored location, as indicated by reference numeral 623 in FIG. 6. This location may be a non-volatile location, such as (for a memory system) a controller's on-chip non-volatile storage, a SPD register or other module or system level non-volatile storage, or (for a specific memory device) an extended page, an OTP register, or in a non-volatile region of flash memory. With the flash memory thus segmented into multiple regions, the design method may be concluded, as indicated by reference numeral 625.

If desired, the method of FIG. 6 may be implemented in connection with an initial architectural design process; alternatively, the method of FIG. 6 may be implemented by machine-readable instructions such as installation software, for example, that, when executed by a processing entity, configures a general purpose system for a custom environment or specific use at time of installation.

i. Wear Leveling.

Wear leveling processes typically employ an algorithm that periodically distributes wear by shifting memory contents around within a given memory (“static wear leveling”), or by distributing new data evenly to all available locations (“dynamic wear leveling”); many different wear leveling algorithms are known to those skilled in the art. Whether wear leveling is appropriate and, if so, which algorithm to use, is left to the discretion of the designer. As indicated earlier, for regions of flash memory that are to be treated as volatile, with very short term memory, it may be possible to perform no wear leveling at all, under the assumption that memory cell quality will generally not deteriorate to a level where retention time is “too short,” or where memory is otherwise managed so that retention time is not an issue (for example, using refresh procedures); conversely, for regions that are treated as fundamentally non-volatile, especially where data writes are infrequent, it may also be desired to not perform static wear leveling since doing so may impact very expectations of long-term non-volatility (e.g., of five or more years). Generally speaking, program counts even on the order of a few dozen may decrease very long retention time of otherwise virgin flash memory. Regions associated with retention periods that are in between these two extremes may be more attractive candidates for wear leveling, that is, where occasional reprogramming is permitted, and where intermediate program counts are permitted; in these situations, wear leveling might be advantageously applied to distribute wear and maximize labeled non-volatility parameters for the region as a whole without appreciably impacting assumptions about retention time.

Simply stated, contrary to conventional wisdom which would typically call for performing wear leveling for all parts of flash, with flash memory segmentation using the principles discussed in this disclosure, it may be possible to not apply wear leveling (e.g., especially “static” wear leveling) to regions, particularly for those regions dedicated to “very” non-volatile storage or “very” volatile storage, and it may be possible to apply wear leveling on a selective basis, independently for individual segments of flash, even for subsections of a single device or chip if desired.

ii. Refresh Processes.

Refresh procedures are typically employed for fundamentally volatile memory, such as DRAM. Typically, volatile memory is characterized as having memory cells where contents remain valid only for at most a few milliseconds, and consequently, data must be repeatedly rewritten into this memory (or refreshed) to keep that data from being lost. If refresh procedures were applied to degradable memory, those procedures would tend to greatly accelerate wear.

Contrary to this traditional wisdom, however, under some circumstances, refresh techniques may be applied to flash memory (i.e., to memory that at least in principle begins its life as non-volatile memory). In this regard, it will be recalled as indicated above that at least one region of flash memory may be treated under the assumption that retention times will ultimately degrade to a point where the memory behaves like volatile memory, that is, becomes fully degraded. In this assumed worst case, it might ultimately be necessary to apply refresh procedures if it is desired to retain contents for this memory even in a powered mode for longer than a few seconds. Therefore, contrary to conventional wisdom, which would be to preserve the fundamentally non-volatile nature of flash memory by not overusing that memory, for regions that are treated as completely “volatile,” over-wear may not be a concern, and the greatly accelerated wear rate caused by deliberate refresh might be inconsequential. For these reasons, refresh procedures can be applied to a purely “volatile” region without substantial negative impact (i.e., under the assumption that refresh will not degrade memory in a manner inconsistent with assumptions of degraded use), and can actually assist with avoiding loss of memory contents during a powered state by very degraded regions of flash memory.

As implied by function block 619, therefore, if the designer wishes to implement a refresh procedure for a specific segmented region of flash memory, the designer determines ultimate retention periods (i.e., for memory that is fully degraded) and ensures that the refresh rate is sufficiently fast to avoid memory loss while the system is fully powered.

C. Management of Stored Demarcation Information and Reallocation.

FIG. 7 illustrates a method 701 of reallocation of memory between regions. The method may be triggered by an event that affects memory region capacity, such as the addition of new hardware or software, reconfiguration of memory, a memory malfunction (e.g., too many bad blocks detected within a given region), a wear profile alert, some other parameter, or a combination of these things, all as indicated by numerals 703 and 705. Existing regions may be ranked according to prescribed volatility and new memory requirements may be identified for each region. Beginning with the “most” non-volatile memory, the system assesses whether or not any changes have occurred given the event in question (e.g., memory malfunction, changing what memory is available to a region, removal of hardware, etcetera). Absent the addition of new memory, if non-volatile memory needs have decreased, memory can be reassigned from a relatively non-volatile region to a more volatile region, but typically not vice versa; otherwise stated, since “volatile” memory in practice may have already been degraded through use, a designer or system reallocation software typically prohibits expansion of non-volatile memory at the expense of “volatile” memory. As this discussion implies, in a two-region system where flash memory is segmented into non-volatile and volatile regions, the non-volatile region can decrease in size but generally will not be increased (unless memory is replaced or memory capacity is expanded). In a three-region system, if the “most” volatile region is to be expanded at the expense of the “most” non-volatile region, a designer may wish to cascade memory between regions by permitting reassignment only to the memory region representing the next greatest range of volatility—for example, by reassigning memory from the non-volatile region to a region of intermediate volatility, and then by reassigning a like amount of memory from the region of intermediate volatility to the most volatile region. In this way, expectations as to longevity of intermediate regions can be maximized, and further, if the implementation is one that permits a user to later add new memory to the system, a cascaded approach may be used to always use new memory as non-volatile memory, recycling used memory by reassignment to volatile regions. These functions are variously indicated by reference numerals 703, 707, 709, 711 and 713 of FIG. 7.

If a situation is encountered where system operation is compromised, for example, due to malfunction or wear, several options exist, as reflected by numerals 715, 717 and 719 in FIG. 7. First, a user may be alerted that a memory device or module needs to be replaced. Second, as an alternative, the operating system or memory subsystem software may be configured to automatically adjust memory usage so as to decrease capacity of the particular region of memory affected by the wear or malfunction; as indicated earlier, for example, a system may be caused to use less non-volatile memory and back things up to hard disk, or other “slower” non-volatile memory (if available), albeit sacrificing attributes such as quick power-up during the existence of the error condition. Third, excess memory, if available, may also be reallocated among regions to address the shortfall. For example, if volatile memory is decreased in an unacceptable manner, it is possible to reassign non-volatile memory to volatile regions on a permanent basis. Fourth, in a system in which additional flash memory was held in reserve and not initially allocated, such spare memory could be assigned to take the place of the faulty or worn memory. Other methods also exist for allowing continued operation during such conditions.

Irrespective of the specific procedure, as memory is reallocated between regions, new demarcation information is stored in memory (e.g., for a “tunable” system) and new page table information is generated, as appropriate, as indicated by reference numeral 719.

D. Management of a Third or Additional Region.

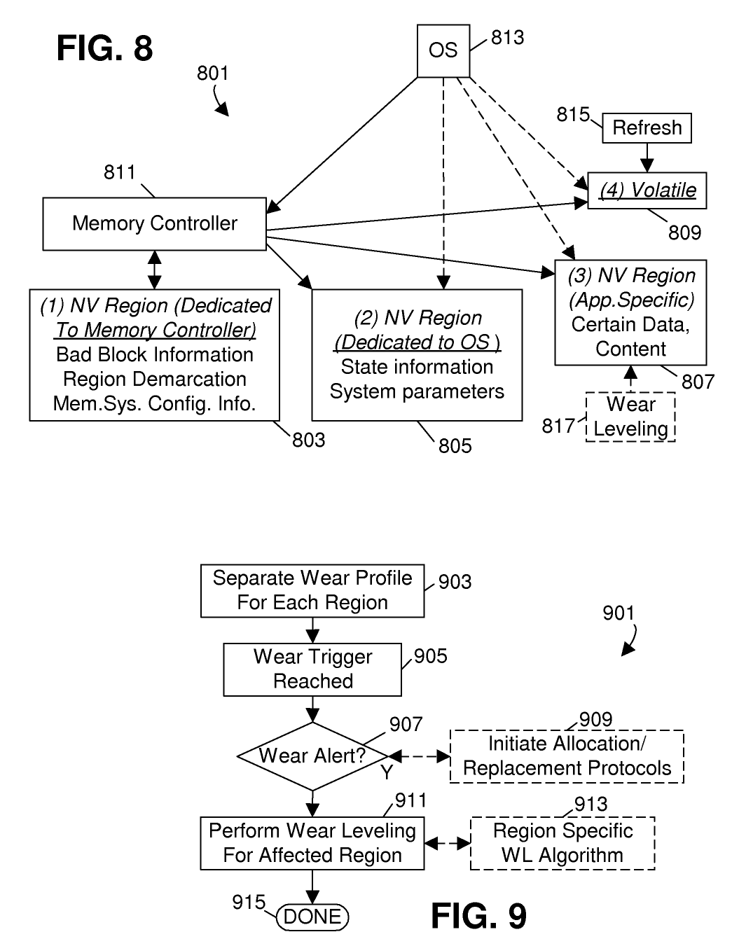

FIG. 8 depicts one embodiment 801 of a system that uses four regions, including a first region 803 for memory subsystem parameters that will rarely be changed, a second region 805 for operating system quick storage of critical system parameters during a power-mode transition and that will have low program counts (but will involve occasional programming, for example, with each power down), a third region 807 dedicated to application specific needs for “quick storage,” which may involve higher program counts than the second region 805, and a fourth region 809 for unregulated, volatile storage, but in which memory contents will essentially be lost once power is lost. In some applications, the third region 807 might be used for special purposes, for example, storage of artistic or security content with special control parameters, if desired. A memory controller 811 uses the first non-volatile storage region 803 for memory subsystem purposes, while an operating system 813 uses second and third non-volatile regions 805 and 807 for operating system and application specific purposes, respectively. Non-volatile storage 809 may be used by each of the controller and the operating system for temporary storage of data, with the assistance of a refresh function 815. As indicated by a dashed-line, optional block 817, wear leveling may optionally be performed for any number of the regions, or none at all; the embodiment of FIG. 8 illustrates a hypothetical where wear leveling is performed only for the third region 807 of flash memory.

E. Wear Leveling and Maintenance of Wear Profiles.

FIG. 9 illustrates a method 901 of applying static wear leveling to selective regions of memory. In particular, a separate wear profile may be maintained for each region of flash memory, whether or not wear leveling is performed for the corresponding region. Wear profiles providing page-based or block based program counts may be used to provide an indication of excessive wear to any specific region, and may be used for reallocation of memory between regions, as well as to identify when a memory module should be replaced (in an implementation adapted for replacement of memory). For those regions in which it is desired to perform wear leveling, the designer identifies as appropriate the conditions desired to trigger wear leveling. Wear leveling may be performed each time memory is programmed or, alternatively, for a region sensitive to a very small range of program counts, it may be desired to employ wear leveling to only occasionally redistribute frequently reprogrammed blocks or pages within a given memory region. Wear profile and wear trigger processes of the method of FIG. 9 are identified by reference numerals 903 and 905, respectively.

If conditions associated with a trigger have been met, the system can inquire (as indicated by decision block 907) as to whether a trigger represents a wear event, such as for example a memory malfunction, or violation of proximity to wear limits tied to a region's volatility assumptions; if an alert is presented, the system can initiate allocation and replacement protocols as indicated by numeral 909, for example, using the method presented above in connection with FIG. 7. Whether or not a wear alert has been triggered, the system can then perform wear leveling for any regions selected by the designer, pursuant to any appropriate wear leveling algorithm or protocol. As indicated earlier, if wear leveling is applied to multiple regions, the algorithm used to perform wear leveling, the frequency of wear leveling and the wear leveling process can be the same or different for each region.

F. Memory Replacement.

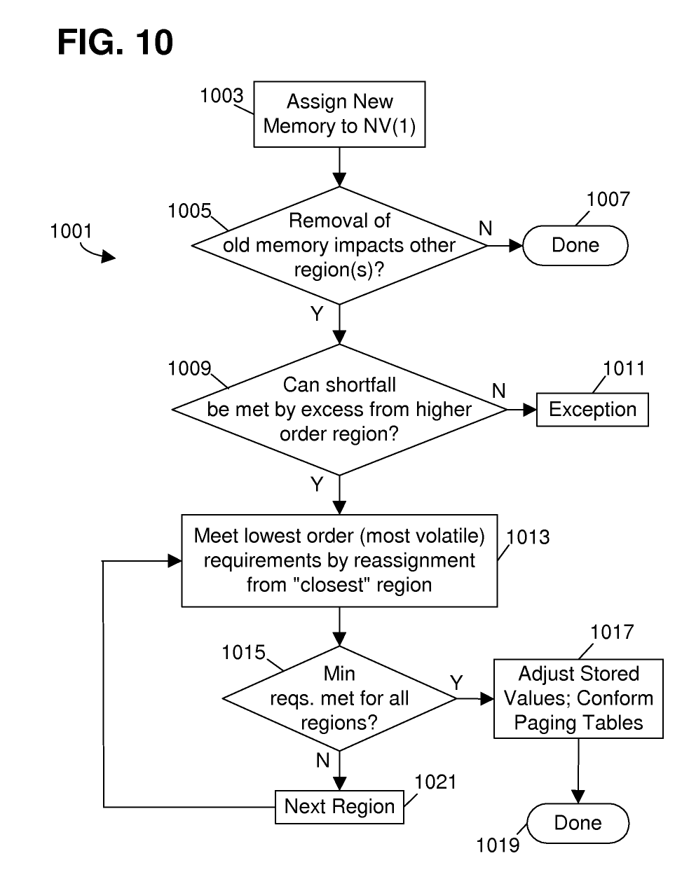

A designer may wish to, depending upon design objectives, create an implementation where flash memory can be replaced once that memory degrades to a certain point. A replaceable memory scheme might be useful, for example, in situations where other forms of non-volatile storage are not available, as for example in an application based exclusively on flash memory or where a designer wishes to provide aggressive retention times based on light or typical usage only. In connection with replacement of one flash memory device in a multi-device system, a designer may wish to adjust how memory removal and replacement affects each region of flash. FIG. 10 is used to present one exemplary method 1001 for performing this adjustment.

Because removal or replacement of memory devices may affect the overall breakdown of regions, and because new memory may provide fresh life for non-volatile regions, it may be desired to preferentially devote any new capacity to non-volatile regions, as indicated by function block 1003. In a system where flash memory consists of plural flash devices, replacement of memory may leave a shortfall for lower order regions (i.e., relatively more volatile regions); accordingly, should such a design constraint be violated, the system may proceed to determine whether the shortfall can be met from excess capacity from a higher order (i.e., relatively more “non-volatile”) region and, if it can, the method 1001 may proceed to fill the shortfall from the next lowest-order region, cascading any resulting shortfall upward. Should there exist a shortfall that cannot be met, then exception processing may be implemented; exception processing may include for example, an error message presented to a user, or readjustment of minimum region sizes, as was previously described above in connection with FIG. 7. Cascading shortfalls in a direction of non-volatility, i.e., by reassigning “non-volatile” pages or blocks in a direction of volatility and reserving new memory or replacement memory to non-volatile regions serves to ensure that any newly added memory can be most efficiently applied, i.e., by transferring in effect, partially degraded memory to “volatile” regions. Once all minimum requirements have been met, the process may be terminated. These functions are variously described by reference numerals 1003, 1005, 1007, 1009, 1011, 1013, 1015, 1017 and 1019 of FIG. 10.

Importantly, there are many other methods that may be used for memory replacement, and the method illustrated by FIG. 10 is only one possible implementation. For example, in an architecturally-defined system, it might be desired to replace all flash memory at once, and not allow for selective memory replacement; alternatively, it might be desired in some implementations to fill volatile demands first, and cascade extra capacity to non-volatile regions, or to provide some other approach suitable to the application.

### III. Region Access

With several design considerations thus presented in the context of region structuring, additional detail will now be presented on the subject region usage and access.

A. Memory System Harbor.

With renewed reference to FIG. 8, it will be seen that in some embodiments, a region may be devoted to non-volatile storage requirements of a memory subsystem. This implementation may be particularly desired if overall system architecture supports multiple forms of memory. In such an embodiment, the memory controller 811 will typically be a flash memory controller, and it may be desired to locally store subsystem operating parameters, such as bad block information, region demarcation, memory system configuration information and other memory subsystem parameters. Ideally, the type of information stored in the non-volatile region dedicated to the flash memory subsystem is information that is not frequently changed, in order to preserve longevity expectations associated with region retention time. Depending on implementation, if it is desired to permit relatively larger program counts, a designer may wish to implement a hybrid procedure, where data is stored in the first region 803 for a predetermined period of time and then is discarded and recreated if a system is not rebooted or powered up within the associated time interval. If desired, a subsystem-specific region 803 may be defined in a manner where it is not even visible to the operating system 813; that is to say, the memory controller may be configured to process data write requests using only regions 805, 807 and 809 while reserving the first region 803 for other purposes.

B. Transition to and from a Reduced Power State.

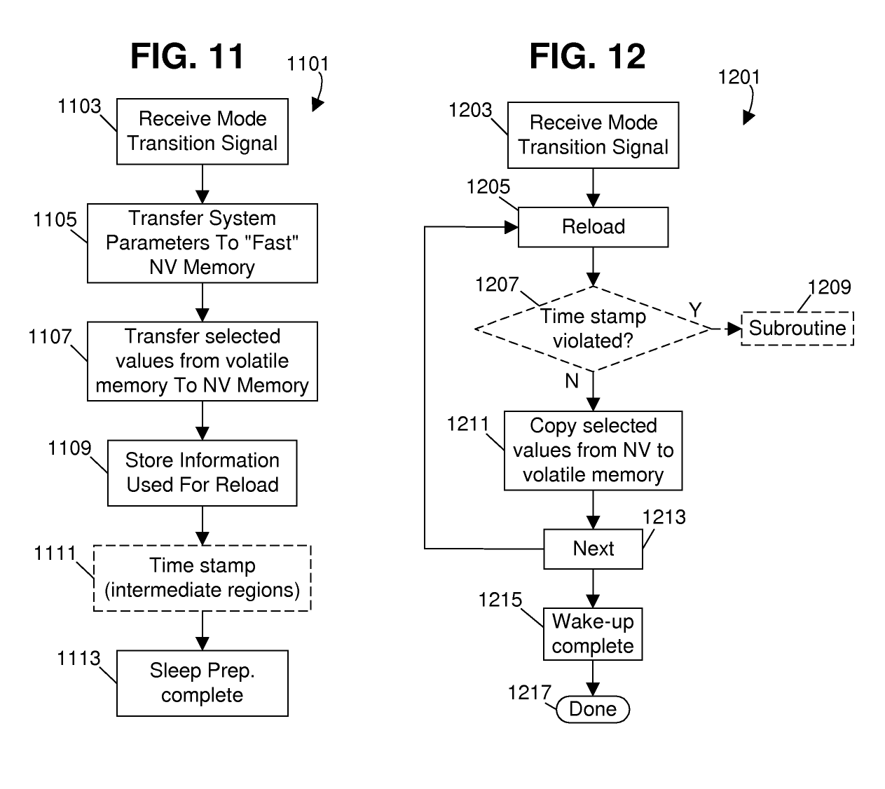

It may be desired to have the operating system or a memory controller always store certain types of data in non-volatile regions of flash memory; alternatively, data can be retained in volatile or other memory and “moved” to non-volatile memory during a transition from a normal mode of operation to a reduced power mode. FIGS. 11 and 12 are used to present exemplary methods by which data (including operating parameters and state data) may be tucked away in non-volatile memory in preparation for a sleep, or other reduced power state.

With reference to FIG. 11, a controller of a memory subsystem is informed that it is to begin preparation for a transition between power modes. Accordingly, the method 1101 may first identify those local memory system parameters that are to be secured in non-volatile memory; generally speaking, this information may include wear profile information, bad memory block information, state information and other system parameters, as just mentioned. A region of flash may be devoted to the flash memory subsystem for this purpose, if desired. Next, the operating system (as appropriate given the implementation) may write other system parameters into non-volatile memory; as introduced above, a master system may also be given its own dedicated region, potentially with different program count and volatility estimates than represented by any region dedicated to the memory subsystem. Finally, the system identifies any parameters stored in volatile memory that should be secured to non-volatile memory—in an implementation having a hard drive or non-flash (non-volatile) memory, this data might be stored quite differently depending on the power mode in question. For example, in transition to a standby mode, it may be desired to store select data in a non-volatile region of flash memory, whereas in a power down procedure, it may be decided from a design standpoint to write data into “slower” memory such as hard disk, if available. Finally, the system stores information needed for return to a fully-powered state, and the power mode transition preparation may then be viewed as complete. These functions are variously indicated by numerals 1103, 1105, 1107, 1109, 1111 and 1113 in FIG. 11.

As mentioned above, in some implementations, it may be desired to create a third or additional region with intermediate volatility assumptions. A dashed-line, “optional” block 1111 is depicted in FIG. 11 to designate the application of time stamp for certain data or en entire region. For example, it may be desired in some implementations to store data (for example, bad block information) in a manner that tolerates a moderate program count, but that also has a reasonable retention time associated with expected system wear, e.g., 3 months. In such an implementation, a time stamp might be applied to the region or to the data, such that if the data is not used or updated within the expected retention time (e.g., 3 months), the data would be assumed to be corrupt and a subroutine would be called to regenerate the data. For example, applied to the bad block data hypothetical mentioned above, a subroutine could be called after three months to test memory anew upon power-up. Such a subroutine is represented, for example, by numeral 1209 in FIG. 12.

FIG. 12 shows functions associated with a return to a fully powered mode, where the functions are roughly the inverse of those described in connection with FIG. 11. In particular, a method 1201 of FIG. 12 begins when the memory subsystem is notified of a power-up or return to a fully-powered mode, as indicated by function block 1203. The system then uses reload information to restore needed system parameters and state information and, if necessary, to load data from non-volatile memory into local controller memory, volatile storage or another location. A decision block 1207 may be called during this process to determine whether any retention assumptions have been violated and, if appropriate, a subroutine 1209 may be called to regenerate the data in question (for example, to as mentioned for the “bad block” hypothetical above). The method may then proceed to restore all data necessary for a full wake-up and, when done, signals that wake-up is complete and that the memory subsystem is ready to resume normal mode operations, all as indicated by numerals 1211, 1213, 1205, 1215 and 1217.

While it should be appreciated that the methods described above in connection with FIGS. 11 and 12 describe a basic transition to a reduced power mode (such as a power-down, standby, sleep or similar function), and reciprocal wake-up, it should be appreciated that these methods are exemplary only, and that nearly any suitable transition protocol may be implemented to manage segmented flash memory within the spirit of this disclosure. For example, the uses and protocols for segmented memory may differ greatly if one is considering a general purpose computing implementation, versus a low-power portable application (such as a PDA, cell phone, or similar handheld or special purpose device), and it generally would be appropriate to tailor transition protocols to the implementation under consideration.

D. Use of Instruction Set Architecture to Specify Region.

As indicated earlier, one embodiment uses differences in instruction set architecture to differentiate between regions. This embodiment will be briefly discussed in connection with FIG. 1. In particular, it should be noted that FIG. 1 shows a controller having a number of inputs, 151, 153 and 155. It is possible to use dedicated instruction sets, represented by command lines 151 and 153, to manage data in regions 113 and 115, respectively, and to couple memory contents with a data bus 155. That is to say, a first instruction can direct access to one region, while a different instruction (e.g., “vol_write” versus “nv_write”) may command access to a different region. If this implementation option is chosen, appropriate access logic may be designed directly into the controller circuit layout, such that software or firmware interpretation of instructions is not necessary. If desired, a combination of the methods mentioned above may also be used, such as use of more than two regions, with a first group of instructions being used to access one region, and a second group of instructions being used to access the other regions. If desired, especially for special purpose applications or security applications, one may also architecturally-reserve a predefined region which cannot be accessed by the operating system (and in this case, there would be no direct instruction set inbound to controller 103 which would provide access to the data).

### IV. Conclusion

By providing a method of segmenting flash memory into regions that are managed differently, the methods and systems described herein potentially enhance the applications to which flash memory can be applied. For example, it was previously mentioned that flash memory exhibits attractive cost, form factor, power characteristics and thermal characteristics, but that variation caused by degradation presents design challenges. By dividing flash memory into multiple regions and fixing retention assumptions associated with program count expectations, the embodiments discussed above help minimize the issue of retention variation caused through degradation, and potentially facilitate use of flash memory on a broader scale, potentially including main memory or other applications that represent non-conventional markets for flash memory. Usable with individual flash memory devices or systems having plural devices, the methods discussed above provide a mechanism by which standard, “off-the-shelf” flash devices might be adapted for use, notwithstanding the degradation issue.

Having thus described several exemplary implementations, it will be apparent that various alterations, modifications, and improvements will readily occur to those skilled in the art. Applications of the principles described herein to systems other than flash memory systems will readily occur to those skilled in the art. Also, as has been alluded-to above, a skilled designer may implement the methods and systems described above using any level of granularity, e.g., including device scale, block, page or other scale. Similarly, memory subsystems and power mode transitions are not the only transactions that can be enabled by the methods and systems set forth herein.

Accordingly, the foregoing discussion is intended to be illustrative only, to provide an example of one particular method and system for configuring a memory system; other designs, uses, alternatives, modifications and improvements will also occur to those having skill in the art which are nonetheless within the spirit and scope of the present disclosure, which is limited and defined only by the following claims and equivalents thereto.

1. A memory system, comprising:
flash memory; and
a controller adapted to write data to the flash memory in one of a first storage region or a second storage region according to whether the data is to be retained within the flash memory during a reduced power mode.

2. The memory system of claim 1, wherein:
the system further comprise a stored value representing demarcation between the first and second regions;
the flash memory includes at least one flash memory device, at least a portion of each region being contained within the flash memory device, such that the demarcation is manifested within the flash memory device.

3. The memory system of claim 1, wherein the reduced power mode includes one of a low-power state, a power conservation mode, a sleep state, a system shut-down, or a power off state.

4. The memory system of claim 1, wherein:
the first storage region is used for volatile storage; and
the controller is adapted to upon transition to a reduced power mode write data to be retained within flash memory during the reduced power mode to the second storage region.

5. The memory system of claim 1, wherein:
the controller is adapted to store memory system operation information, including at least bad block information for flash memory and information representing demarcation between the first and second regions, in the second region; and
the memory system further comprises means for refreshing the first storage region during a normal, powered mode of operation.

6. The memory system of claim 1, further comprising means for performing wear leveling on one region, independent of any wear leveling performed on the other region.

7. The memory system of claim 1, further comprising a wear leveling function, characterized in that no wear leveling is performed for the first storage region of flash memory.

8. The memory system of claim 1, further comprising:
a stored value that identifies demarcation of the first region from the second region: and
redefinition logic that permits the stored value to be redefined, to increase memory associated with the first region at the expense of the second region, but not vice-versa.

9. The memory system of claim 1, wherein:
the memory system includes a plurality of flash memory devices, each having its own interface;
the memory system further comprises a stored value representing demarcation between the first region and the second region in at least one of the plurality of flash memory devices; and
the controller is to use the stored value to write data via an interface to either of the first region or the second region for a device corresponding to the interface, such that a single interface for a corresponding flash memory device is used for data operations for both regions.

10. The memory system of claim 9, wherein:
each of the plurality of memory devices has multiple pages allocated to the first region and multiple pages allocated to the second region; and
the memory system further comprises a stored value for each flash memory device that represents demarcation between the first region and the second region for the corresponding memory device.

11. The memory system of claim 10, wherein the stored value for each flash memory device is stored in the second region for the corresponding flash memory device.

12. The memory system of claim 10, wherein the stored value for each flash memory device is stored in one of a memory module serial presence detect register, an architecturally reserved non-volatile address in the corresponding flash device, a one-time programmable space in the associated flash device, or an extended page of the corresponding flash device.

13. The memory system of claim 1, wherein a demarcation between the first region and the second region is architecturally-defined.

14. The memory system according to claim 1, wherein:
the memory system further comprises a third region of flash memory;
the controller is to write data to the third region of flash memory via the data interface in dependence upon whether data is to stored in memory used for relatively low program count operations; and
the memory system further comprises a wear leveling mechanism that performs wear leveling for the third region independent of any wear leveling performed for the first region and independent of any wear leveling performed for the second region.

15. The memory system of claim 14, wherein:
the memory system further comprises a refresh mechanism that refreshes contents of at least the first region; and
the memory system is further characterized in that no wear leveling is performed for the first region.

16. The memory system of claim 1, wherein:
the system further comprises write instruction logic that differentiates data to be stored in the first region from data to be stored in the second region based upon a data write instruction;
the controller defines a memory address for data to be written in dependence upon whether the first region or the second region is to be written to; and
the controller is adapted to write data to flash memory via the interface notwithstanding whether data is to be written to the first region or the second region.

17. A method of managing flash memory, comprising:
segmenting flash memory into at least a first storage region and a second storage region;
receiving data to be stored within the flash memory;
storing the data within the second storage region if the data is required to be retained during a reduced power mode; and
storing the data in the first region of flash memory if the data is not required to be retained during a reduced power mode, the second region being non-overlapping with the second region.

18. The method of claim 17, applied to a flash memory device having an interface, the method further comprising storing data via the interface to a selective one of the first region or the second region, such that a single interface is used notwithstanding whether data is intended for the first region or the second region within the flash memory device.

19. The method of claim 17, further comprising:
defining at least three storage regions within flash memory;
maintaining separate wear level profiles for each region; and
performing wear leveling for one region independent from other regions in dependence upon the associated wear level profile.

20. The method of claim 17, wherein partitioning includes partitioning a flash memory device.

21. The method of claim 17, further comprising:
determining whether memory space within the flash memory should be reclassified for high program count operations;
responsive to determining whether memory space should be reclassified, changing a stored value representing demarcation between the first region and the second region in a manner that increases size of the first region relative to the second region, but not vice-versa; and
writing the stored value to a predetermined location that is one of a memory module serial presence detect register, a reserved non-volatile address in a flash memory device, a one-time programmable space in a flash memory device, or an extended page of a flash memory device.

22. The method of claim 21, embodied in a main memory application, the method further comprising:
reserving the first region for volatile storage; and
performing wear leveling for the second region independently of any wear leveling performed for the first region.

23. The method of claim 17, further comprising refreshing contents of the first storage region.

24. A method of configuring main memory based at least in part upon flash memory, comprising:
segmenting flash memory so that a first storage region is allocated to volatile storage and a second storage region is allocated to other storage; and
maintaining the first storage region in a different manner than the second storage region, including performing at least one of (a) establishing profiling for wear leveling that is different for the second storage region than for the first storage region, or (b) establishing a refresh operation for the first storage region that is independent from the second storage region.

25. The method of claim 24, further comprising:
determining a quantity of flash memory that is to be used in a normal mode of operation for volatile storage of data;
programmatically segmenting flash memory so that a first storage region is allocated to volatile storage and a second storage region is allocated to storage of data that is to be accessible following a reduced power mode; and
permitting selective reallocation of flash memory space between the first storage region and the second storage region in a single direction only, to permit increase memory associated with the first region at the expense of the second region, but not vice-versa.

26. The method of claim 24, further comprising establishing a wear profiling scheme that profiles wear for the second region independent of any wear leveling performed for the first region.

27. The method of claim 24, wherein the flash memory includes a flash memory device and segmenting includes segmenting flash memory within the device so that a first storage region within the device is allocated to volatile storage and a second storage region within the device is allocated to storage of data that is to be accessible following a reduced power mode

28. The method of claim 24, further adapted to configure plural flash memory devices, the method further comprising:
dividing flash memory space represented by the plural flash memory devices into at least two storage regions;
performing wear leveling for at least one storage region independently than for any other storage region.

29. The method of claim 24, wherein:
segmenting includes programmatically segmenting flash memory so that the first storage region is allocated to volatile storage and the second storage region is allocated to storage of data that is to be accessible following a reduced power mode;
the method further comprises storing demarcation information in non-volatile memory, the demarcation information adapted for use by a memory controller in determining where data to be written to each region should be stored within flash memory.

30. The method of claim 24, wherein segmenting includes storing demarcation information in non-volatile memory for each one of plural flash memory devices, each of the plural devices having memory allocated to the first region and memory allocated to the second region, the demarcation information for each of the plural devices demarking the regions within the corresponding device, the demarcation information adapted for use by a memory controller in determining where data to be written to each region should be stored within the corresponding flash memory device.

31. A method, comprising:
establishing a refresh operation for a first storage region of flash memory that is independent from a second storage region of flash memory, the first storage region used in a normal mode of operation for volatile storage of data;
establishing a wear leveling operation for the second storage region that is independent from any wear leveling for the first storage region; and
writing data to flash memory in a normal mode of operation in dependence upon the whether data is to be stored in the first storage region or the second storage region.

32. The method of claim 31, wherein:
the method further comprises reading a stored value from non-volatile memory to distinguish location of the first storage region from the second storage region within flash memory; and
the writing of data for at least one of the storage regions is performed in partial dependence upon the stored value.

33. An apparatus comprising instructions stored on machine-readable media, the instructions when executed causing a machine to:
establish a refresh operation for a first storage region of flash memory that is independent from a second storage region of flash memory, the first storage region used in a normal mode of operation for volatile storage of data;
establish a wear leveling operation for the second storage region that is independent from any wear leveling for the first storage region; and
write data to flash memory in a normal mode of operation in dependence upon the whether data is to be stored in the first storage region or the second storage region.

34. The apparatus of claim 33, wherein:
the instructions further include instructions that when executed cause a controller to read a stored value from non-volatile memory to distinguish location of the first storage region from the second storage region within flash memory; and
the writing of data for at least one of the storage regions is performed in partial dependence upon the stored value.

35. A method of operating a flash memory device, comprising:
reading out of non-volatile storage demarcation information that distinguishes a first storage region within the flash memory device from a second storage region;
determining whether data is to be stored in the first storage region or the second storage region based upon whether the data is to be accessible following a reduced power mode; and
storing data in the flash memory device in dependence upon the demarcation information and whether data is to be accessible following a reduced power mode.

36. The method of claim 35, where the second storage region is associated with data to be accessible following a reduced power mode, wherein the reading out of non-volatile storage includes reading the demarcation information from the second storage region.

37. The method of claim 35, wherein the reading out of non-volatile storage includes reading the demarcation information from one of a serial presence detect register of a memory module or reserved memory of a flash controller.

38. The method of claim 35, further comprising establishing a wear profiling scheme that profiles wear for the second region independent of any wear leveling performed for the first region.

39. A flash memory controller, comprising:
a register having at least one value for each flash memory device managed by the controller, each value representing address demarcation within the associated flash memory device; and
a wear leveling state machine coupled to the register;
wherein the wear leveling state machine uses the register values to delineate different access profiles for different ranges of flash memory.

40. A flash memory controller according to claim 39, further comprising initialization logic that polls each flash memory device managed by the controller to retrieve the values, and that responsively populates the register with the values.

41. In a main memory system including at least one memory device that suffers from life cycle wear, a method comprising:
programmatically-segmenting main memory, including memory space represented by the at least one memory device that suffers from life cycle wear, into at least two segments, including at least one segment for volatile memory storage and at least one segment for storage of data that is to be accessible following a reduced power mode;
storing information reflecting manner in which memory has been segmented; and
processing data write requests by determining a segment into which data should be written, using the stored information, and based upon whether the data to be written is to be accessible following a reduced power mode.

42. The method of claim 41, wherein processing data write requests includes:
for data that is specific to a memory subsystem, storing the data in a segment of memory for data that is to be accessible following a reduced power mode; and
for data for which a copy of the data also resides in nonvolatile memory, storing the data in a segment of memory associated with volatile memory storage.

43. The method of claim 41, further comprising logic that in preparation for transition to a reduced power mode writes predetermined data into a segment of flash memory used for data that is to be accessible following a reduced power mode.

44. The method of claim 41, further comprising:
generating a mapping of address space for each of at least two memory segments across plural flash devices; and
performing wear leveling separately for at least one segment independent from any wear leveling for any other segment.
